(19) United States
(12) Patent Application Publication
(10) Pub. No.: US 2010/0324884 A1
(43) Pub. Date: Dec. 23, 2010

(54) ENHANCED TELECOMMUNICATION SYSTEM

(76) Inventor: Therese M. Jeffrey, Bartlett, IL (US)

Correspondence Address: Hallihan IP Partners, LLC, 117 N. Jefferson Street, Suite 200, Chicago, IL, 60661, US

(21) Appl. No.: 12/666,574

(22) PCT Filed: Jun. 26, 2007
(86) PCT No.: PCT/US07/72129

§ 371 Date: Dec. 23, 2009

(51) Int. Cl. G06F 17/28; G10L 21/00

(52) U.S. Cl. 704/2; 704/277; 704/E21.001

(57) ABSTRACT

A communication system for dynamically translating a verbal communication from a first language to a second language is disclosed. The system includes a communication device operably connected to a translation module which possesses the capability of converting a verbal communication in the first language into a verbal communication in the second language and a transcript in the second language. The system also includes an operator terminal operably connected to the translation module via a communication link. The operator terminal possesses the capability of generating and transmitting a verbal and/or written communication in the second language to the translation module wherein the verbal and/or written communication is dynamically translated into a verbal communication in the first language.

### FIELD OF THE INVENTION

The invention is an enhanced telecommunication system having language translation capabilities. In particular, the invention is a communication system including one or more modules for providing dynamic or real-time language-to-language transcription and translation within a telecommunications network.

### BACKGROUND OF THE INVENTION

When a call to 911 is placed, the call is routed to a Public Safety Answering Point where an operator or dispatcher answers the call. Depending on the particular nature of the call, certain security, safety and emergency resources may be dispatched in response to the call. For example, in cases where the caller is reporting the occurrence of an accident, police and/or paramedic personnel may be sent to the caller's location.

Ideally, the caller gives the operator specific location information so that if any resources are to be dispatched, the resources are directed to the correct location. However, if the caller and the operator do not speak the same language obtaining such location and emergency information can be difficult and/or time consuming. For example, in most U.S. cities when a non-English speaking, caller places a 911 call the operator keeps the caller on the line while an interpreter is located. However, it often, takes five or more minutes to get an interpreter on the line. Accordingly, there is a need and a demand for an enhanced communication system which can rapidly translate verbal communications in a caller's language to an operator's or dispatcher's language.

Additionally, the identification and development of a pool of interpreters can become costly and unwieldy. This is particularly true in larger cities where a wide variety of immigrant populations speaking numerous languages reside. Maintaining and identifying interpreters in rural areas and/or larger counties can also be difficult particularly where the number of qualified interpreters may be small. Thus, there is a need and a demand tor an enhanced communication system for translating verbal communications in a caller's language to an operator or dispatcher's language which can be economically implemented and maintained.

Further, because many languages such as, for example, Chinese and Vietnamese, have several dialects it can be difficult to locate a qualified interpreter who can accurately translate for a caller who speaks a different dialect than the interpreter. Therefore, there is a need and a demand for an enhanced communications system which can accurately and efficiently translate a verbal communication in a caller's language to an operator or dispatcher's language.

In addition to emergency communication networks and network providers, many businesses and multi-national corporations also typically rely on interpreters or other personnel to act as operators to receive and direct calls from various parts of the world to appropriate personnel who can assist callers. However, recruiting and maintaining staff for such assignments can be difficult and/or costly particularly in locations wherein ethnic and/or regional diversity is limited. Accordingly, there is also a need and a demand for an enhanced communication system which can accurately translate verbal communications into or from a caller's language to assist in directing an inquiry to appropriate personnel,

### SUMMARY OF THE INVENTION

A general object of the invention is to provide an enhanced communication system for facilitating verbal communications between parties who speak different languages.

A particular object of the invention is to provide an enhanced communication system which can dynamically and accurately translate a verbal communication in a caller's language into a verbal communication and/or a written transcript in an operator or dispatcher's language.

A more specific object is to overcome one or more of the problems described above.

The general object of the invention can be attained, at least in part, through a communication system including a communication device for transmitting a first verbal communication in a first language; a translation module for receiving the first verbal communication and transmitting a second verbal communication in a second language and/or a first transcript in the second language; and an operator terminal for receiving the second verbal communication and/or the first transcript and transmitting a third verbal communication in the second language and/or a second transcript in the second language via a communication link to the translation module. The translation module possesses a capability of translating verbal and/or written communications from the first language into verbal and/or written communications in the second language and vice versa.

The prior art generally fails to provide a communication system which possesses the capability of dynamically converting verbal and/or written communications from one language to another language that is as effective as desired in satisfying one or more of the above-identified performance criteria. Additionally, the prior art has generally failed to provide a communication system which can be economically and readily implemented by communities and/or businesses wherein the availability of qualified interpreters may be limited because of the wide variety of spoken languages and/or the lack of regional or ethnic diversity.

The invention also comprehends a communication system that can include a communication device, a translation module, a first communication link, an operator terminal, a second communication link and a third communication link. The communication device is capable of transmitting a first verbal communication in a first language. The translation module is capable of sending and receiving verbal and/or written communications from the communication device and includes a voice generation unit capable of translating the first verbal communication into a second verbal communication in a second language. The translation module also includes a transcription unit capable of transcribing the first verbal communication into a first transcript in the second language. The first communication link is provided to transmit the second verbal communication and the first transcript to the operator terminal. The operator terminal includes an audio input device for inputting a third verbal communication in the second language and a text input device for generating a second transcript in the second language. The second communication link is provided to transmit the third verbal communication to the voice generation unit wherein the voice generation unit is capable of generating a fourth verbal communication in the first language. The third communication link is provided for transmitting the fourth verbal communication to the communication device. The communication system can additionally include a fourth communication link for transmitting a text message in the first language generated from the second transcript to a text unit of the communication device.

The invention further comprehends a method for responding to an emergency communication which includes accessing a communication system via a communication device which transmits a first verbal communication in a first language to a translation module wherein the first verbal communication is translated into a second verbal communication in a second language in a voice generation unit and transcribed into a first transcript in the second language in a transcription unit. The second verbal communication and the first transcript are transmitted to an operator terminal via a first communication link. A third verbal communication in the second language is inputted, using an audio device in the operator terminal. The third verbal communication is transmitted via the second link to the voice generation unit wherein the third verbal communication is translated into a fourth verbal communication in the first language, The fourth verbal communication is transmitted to the communication device via the third communication link.

The invention additionally comprehends a communication system for dynamically translating communications between a caller and an operator. Such a communication system includes a communication device, a translation module, an operator terminal and an automated menu module to facilitate language identification and information collection. The automated menu module receives a first verbal communication in a first language from the communication device and possesses a capability of identifying the first language, transmitting queries in the first language to the communication device, and receiving commands from the communication device in the first language. The translation module receives the first verbal communication and a query/command string from the automated menu module and possesses a capability of translating the first verbal communication into a second verbal communication in a second language and the first verbal communication and the query/command string into a first transcript in the second language. The operator terminal receives the second verbal communication and the first transcript from the translation module and possesses a capability of generating and transmitting a third verbal communication in the second language to the translation module. The translation module further possesses a capability of translating the third verbal communication into a fourth verbal communication in the first language and transmitting the fourth verbal communication to the communication device.

Other objects and advantages will be apparent to those skilled in the art from the following detailed description taken in conjunction with the drawings and the appended claims.

### BRIEF DESCRIPTION OP THE DRAWING

FIG. 1 is a schematic depicting a communication system in accordance with one embodiment of the invention.

FIG. 2 is a schematic depicting a communication system in accordance with another embodiment of the invention.

### DETAILED DESCRIPTION

In general the 911 communication system provides an efficient and effective mechanism for rapidly and reliably dispatching emergency resources such as, for example, police, paramedic and/or fire personnel in response to a distress call. However, as discussed above, the efficiency, reliability and/or effectiveness of the 911 system can be compromised when a caller and operator speak different languages and interpreters are difficult to locate in a timely manner. Accordingly, a communication system has been developed to facilitate communication between parties who speak different languages.

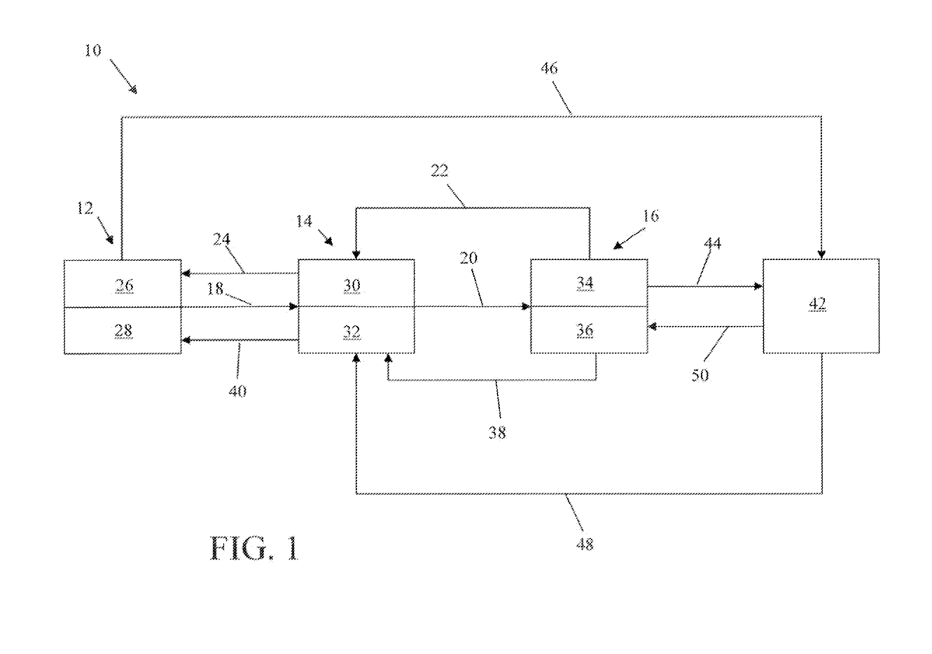

In accordance with certain embodiments, a communication system, generally designated by numeral 10 in FIG. 1, designed to dynamically translate verbal communications between a caller and an operator includes a communication device 12, a translation module 14, and an operator terminal 16. The communication system 10 can additionally include at least one remote terminal 42. Advantageously, the communication system 10 is integrated with or operably connected to a wired, wireless, voice over internet protocol (VoIP), shortwave and/or two-way communication network.

The communication system 10 further includes at least one communication link 18 for transmitting verbal and/or written communications between the communication device 12 and the translation module 14. The communication system 10 additionally includes a first communication link 20 operably connecting the translation module 14 to the operator terminal 16, a second communication link 22 for transmitting a verbal communication from the operator terminal 16 to the translation module 14, and a third communication link 24 for transmitting a verbal communication from the translation module 14 to the communication device 12.

The communication device 12 possesses a capability of transmitting verbal and/or written communications in a first or caller's language via communication link 18 to the translation module 14 wherein the communications are dynamically translated into a second or operator's language. The communication device 12 can be, for example: a phone such as a landline, wireless, mobile or cellular phone, a VoIP phone; a two-way radio such as a walkie-talkie handset; a shortwave or Ham radio set; or any other suitable communication device. Suitably, the communication device 12 is operably connected to a communication network as described above such that calls or communications initiated from the communication device 12 can be transmitted to the communication system 10.

In accordance with certain embodiments, the communication device 12 can include an audio unit 26 for sending and receiving verbal communications in a first or caller's language and a text unit 28 for sending and receiving transcripts or text messages in the first or caller's language,

The translation module 14 possesses a capability of receiving verbal and/or Written communications, via communication link 18 and second communication link 22 and sending verbal and/or written communications via first communication link 20 and third communication link 24. Suitably, the translation module 14 possesses a capability of generating a second verbal communication in a second or operator's language and a first transcript in the second language. Advantageously, the translation, module 14 possesses a capability of simultaneously generating the second verbal communication and the first transcript. In accordance with certain embodiments, the translation module 14 can include a voice generation unit 30 for generating the second verbal communication and a transcription unit 32 for generating the first transcript.

In practice, the voice generation unit 30 possesses a capability of receiving a first verbal communication in a first or caller's language from the communication device 12 via communication link 18. The voice generation module 30 further possesses a capability of translating the first verbal communication into a second verbal communication in a second or operator's language.

The transcription module 32 possesses a capability of receiving the first verbal communication from the communication device 12 via communication link 18 and further possesses a capability of generating or transcribing the first verbal communication into a first transcript in the second or operator's language. Additionally or alternatively, the transcription unit 32 possesses a capability of receiving a written or text message in the first or caller's language from the text unit 28 of the communication device 12 via communication link 18. The transcription unit can further possess a capability of generating a transcript in the second or operator's language from the first verbal communication.

in accordance with one embodiment, the voice generation unit 30 can include an automated, program such as a software program which possesses a capability of translating a verbal communication in a first language into a verbal communication in a second language. Additionally or alternatively, the voice generation unit 30 can include a software program capable of translating a written document or written communication into a verbal communication. The voice generation unit 30 can still further additionally or alternatively include a software program capable of transcribing a verbal communication in a first language into a written communication in the first language, translating the written communication in the first language into a written communication in a second language, and translating the written communication in the second language into a verbal communication in the second language.

Suitably, the transcription unit 32 can include an automated or software program such as, for example, a program similar to Dragonspeak®, which is capable of transcribing speech into a written document. Additionally or alternatively, the transcription unit 32 can include a software program capable of translating text in a first or caller's language into a transcript or written document in the second or operator's language.

In accordance with certain embodiments, the translation module 14 can receive a first verbal communication in a first or caller's language from the communication device 12 via communication link 18 which can be routed to the transcription unit 32 wherein a first transcript in a second language can be generated. The first transcript can then be routed to the voice generation unit 30 wherein the first transcript is translated into a second verbal communication in a second or operator's language.

Advantageously, the translation module 14 further possesses a capability of transmitting the second verbal communication and the first transcript to the operator terminal 16 via first communication link 20. Suitably, the translation module 14 possesses a capability of simultaneously or near simultaneously transmitting the second verbal communication and the first transcript to the operator terminal 16. As used herein, the terms “simultaneously” or “near simultaneously” refers to communications and/or events which are transmitted, received and/or occur concurrently or within a short period of time of each other, i.e., such as within a few seconds, or which occur within a single data transmission.

The operator terminal 16 suitably possesses a capability of receiving the second verbal communication and the first transcript via the first communication link 20. Advantageously, the operator 16 possesses a capability of simultaneously receiving the second verbal communication and the first transcript. The operator terminal 16 can further possesses a capability of transmitting a third communication in the second or operator's language, a second transcript in the second or operator's language or a combination thereof to the translation module 14 via one or more communication links. For example, the operator terminal 16 can possess the capability of transmitting the third communication to the translation module 14 via the second communication link 22 and the capability of transmitting the second transcript to the translation, module 14 via a fourth communication link 38.

In accordance with certain embodiments, the operator terminal 16 can include an audio device 34 for inputting a third verbal communication in the second or operator's language and a text input device 36 for generating a second transcript in the second or operator's language.

In practice, an operator upon hearing the second verbal communication can utilize the audio device 34 to input a third verbal communication in the second or operator's language which the operator terminal 16 can transmit via second communication link 22 to the translation module 14. In accordance with certain embodiments, the third verbal communication can be translated in the voice generation unit 30 directly into a fourth verbal communication in the first or caller's language. Alternatively, the third communication can be transmitted from the operator terminal 16 to the translation module 14 wherein the third communication is routed to the transcription unit 32. In the transcription unit 32 the third verbal communication can be transcribed into a third transcript which can then be routed to the voice generation unit 30 where the fourth verbal communication in the first or caller's language can be generated. The fourth verbal communication can then be transmitted by the translation module 14 via third communication link 24 to the communication device 12 such that a caller hears a response to the first verbal communication, in his or her own language.

Additionally, an operator can use the text input device 36 to enter a second transcript in the second or operator's language which can be transmitted from the operator terminal 16 via fourth communication link 38 to the translation module. In practice, the second transcript can be routed to the transcription unit 32 which suitably possesses a capability of translating the second transcript into a text message in the first or caller's language. The text message can then be transmitted via a text link 40 to the communication device 12 wherein a caller can view an operator's written response to the first verbal communication on the text device 28 in his or her own language.

Suitably, an operator or dispatcher utilizing the operator terminal 16 can he provided an option to program the translation module 14 to designate the second or operator's language. Additionally, an operator or dispatcher utilizing the operator terminal 16 can be provided an option to program the translation module 14 to select, change or correct a language designated by the translation module 14 as the first or caller's language in the event that the translation module 14 incorrectly identifies the caller's language or dialect. In this case, communication system 10 allows the operator to hear at least a portion of a caller's verbal communication in order to identify the first or caller's language.

In accordance with certain embodiments, the communication system 10 can further include a remote terminal 42. Suitably, the remote terminal 42 possesses a capability of receiving and sending verbal and/or written communications such as in the form of audio files, text files or combinations thereof via a data link 44. The remote terminal 42, for example, can be similar in function and operation to the operator terminal 16 wherein a third party such as an interpreter and/or a police, fire or paramedic personnel can receive copies of communications between a caller accessing the communication system 10 and an operator or dispatcher using the operator terminal 16. Additionally, such third party can subsequently utilize the remote terminal 42 to generate additional written and/or verbal communications which can be transmitted to the translation module 14 via a first remote link 46, to the communication device 12 via a second remote link 48, and/or to the operator terminal 16 via a third remote link 50 such that the third party can obtain or provide additional information to the caller and/or the operator.

In accordance with certain embodiments, the remote terminal 42 can be located within the same jurisdiction as the operator terminal 16, Alternatively, the remote terminal 42 can be located in a different jurisdiction than the operator terminal 16. As used herein, the term “jurisdiction” is defined as an office, town, city, county, state and/or other organisational unit or state or federal governmental body. For example, the operator terminal 16 can be located in a first city and the remote terminal 42 may be located within a second city. Additionally, or alternatively, the operator terminal 16 can be located within a state jurisdiction and the remote terminal 42 may be located within a federal jurisdiction.

Thus, in practice, a third party, such as an interpreter and/or a police, fire or paramedic personnel, in a second jurisdiction can receive copies of communications between a caller accessing the communication system 10 and an operator or dispatcher using the operator terminal 16 in a first jurisdiction. Additionally, such third party in the second jurisdiction can subsequently utilize the remote terminal 42 to generate additional written and/or verbal communications which can be transmitted to the translation module 14 via a first remote link 46, to the communication device 12 via a second remote link 48, and/or to the operator terminal 16 via a third remote link 50 such that the third party can obtain or provide additional information to the caller and/or the operator located within the first jurisdiction.

Thus, in accordance with one embodiment, the remote terminal 42 suitably possesses a capability of receiving a copy of a communication selected from the group consisting of the first, second of third verbal communication, the first or second transcript, and combinations thereof. Advantageously, the remote terminal 42 possesses a capability of receiving copies an additional communication generated and/or transmitted within the communications system 10 such as, for example, the fourth verbal communication and/or text messages transmitted between the text unit 28 and the transcription unit 32.

In another aspect, a method for responding to an emergency communication using communication system 10 includes accessing the communication system 10 and transmitting a first verbal communication in a first or caller's language from the communication device 12 to the translation module 14 via communication link 18 wherein the first verbal communication is translated into a second verbal communication in a second or operator's language and a first transcript in the second or operator's language. The second verbal communication and the first transcript are transmitted via the first communication link 20 to the operator terminal 16 wherein a third verbal communication in the second or operator's language is inputted using the audio device 34. The third verbal communication is transmitted via the second communication link 22 to the voice generation unit 30 wherein a fourth verbal communication in the first or caller's language is generated. The fourth verbal communication is then transmitted to the communication device 12 via the third communication link 24.

The method for responding to an emergency communication can further include generating a second transcript in the second or operator's language using the text input device 36 and transmitting the second transcript to the transcription module 32 via the fourth communication link 38 wherein the transcription module 32 generates a text message in the first or caller's language. The text message is then transmitted from the translation module 14 to the text unit 28 via text link 40 such that the caller can read an operator's response to the emergency communication in his or her own language.

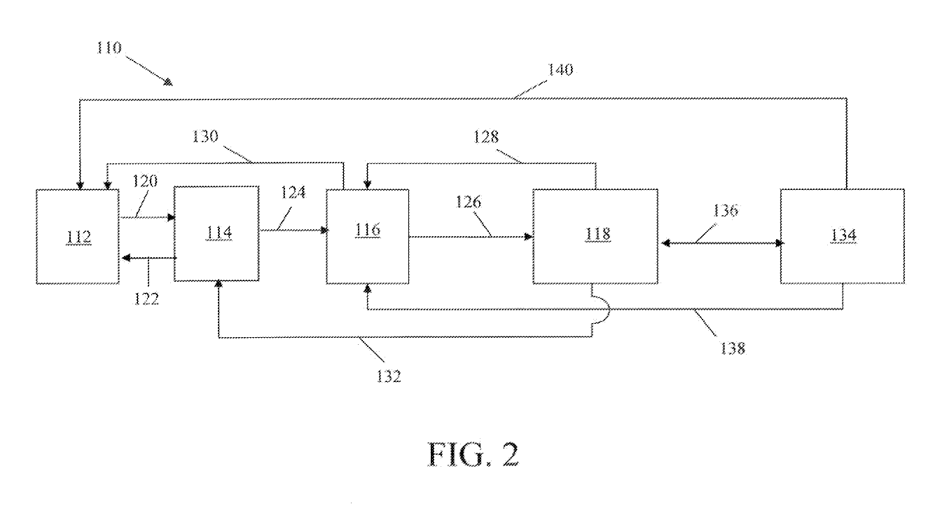

In accordance with an additional embodiment of the invention, as illustrated In FIG. 2, a communication system 110 for dynamically translating verbal and/written communications between a caller and an operator or dispatcher who speak different languages includes a communication device 112, an automated menu module 114, a translation module 116 and an operator terminal 118. In practice, the communication device 112, translation module 116 and operator terminal 118 can be include individual units and/or possess capabilities as described above in conjunction with communication device 12, translation module 14 and operator terminal 16, respectively, and shown in FIG. 1.

The automated menu module 114 suitably possesses a capability of recognizing or identifying a first or caller's language, selecting a preprogrammed menu based upon the identified first or caller's language, and transmitting at least one verbal and/or written query selected from the preprogrammed menu to the communication device 112. In practice, a first verbal and/or written communication in the first or caller's language is transmitted from the communication device 112 to the automated mean module 114 via a first communication link 120. Suitably, the automated menu module 114 receives the first verbal and/or written communication, searches a language database to identify the first or caller's language, selects a preprogrammed menu based upon the identified first language and transmits at least one query in the first or caller's language to the communication device 112 via a second communication link 122. In practice, a caller can respond to such queries by sending commands to the automated menu module 114 via the first communication link 120. Such commands can be in the form of verbal communications, text messages or key strokes transmitted from the communication device 112. Such commands can suitably prompt the selection of additional preprogrammed menus by the automated menu module 114 and transmission of additional queries in the first or caller's language to the communication device 112. Advantageously, the automated menu module 114 can be programmed to transfer the caller to an operator or other suitable personnel after receiving a predetermined number of commands from the communication device 112 and/or based upon a predetermined query/command string length. Additionally, the automated menu module 114 can be programmed to allow a caller to enter a command to bypass the automated menu module 114. In such an event, the first verbal and/or written communications can he transmitted from the automated menu module 114 to the translation module 116 via a first communication link 124.

In practice, the first verbal and/or written communication and a query/command string in the first language can be transmitted via the first communication link 124 to the translation module 116 wherein the first verbal and/or written communication and the query/command string can be translated into a second verbal communication in a second or operator's language and a first transcript in the second language.

The translation module 116 can possess a capability of transmitting the second verbal communication and the first transcript to the operator terminal 118 via a second communication link 126. As described above in conjunction with the operator terminal 16, an operator or dispatcher can utilize the operator terminal 118 to input and transmit verbal and/or written communications such as, for example, a third verbal communication in the second or operator's language, to the translation module 116 via a third communication link 128. Verbal and/or written communications from the operator terminal 118 can be translated into verbal and/or written communications in the first or caller's language such as, for example, a fourth verbal communication in the first or caller's language, such as by the processes or steps described above in conjunction with translation module 14. Such verbal and/or written communications can then be transmitted via a fourth communication link 130 to the communication device 112 wherein the caller receives an operator or dispatcher's response in his or her own language.

Advantageously, the operator terminal 118 can include a capability of selecting, changing or correcting a language and/or preprogrammed menu selection made by the automated menu module 114. In practice, an operator or dispatcher can suitably transmit a prompt via a data link 132 to the automated menu module 114 such that a different language is identified. Alternatively or additionally, the operator can transmit a prompt to the automated menu module 114 via data link 132 such that additional or alternative preprogrammed menus are selected and communicated to a caller via the second communication link 122.

In accordance with certain additional embodiments, the communication system 110 can further include a remote terminal 134 which can possess one or more of the capabilities described in detail above in conjunction with remote terminal 42. In practice, a third party such as, for example, an interpreter or police, fire and/or paramedic personnel, located within the same jurisdiction or within a different jurisdiction, can utilize the remote terminal 134 to send verbal and/or written communications to and receive such communications from the operator terminal 118 via a first remote link 136, send verbal and/or written communications to the translation module 116 via a second remote link 138, and/or communicate directly with a caller via a third remote link 140.

Thus, as described in detail above, the invention provides enhanced communication systems which can dynamically and efficiently translate verbal and/or written communications in a caller's language into verbal and/or written communications in an operator or dispatcher's language. Further such communications systems can be economically utilized or employed by communities or regions where identifying and/or retaining qualified interpreters can be cost prohibitive. Such communication system can additionally be used by communities and/or companies that deal with a diverse population which speaks a variety of languages or dialects to reduce staffing needs and improve communication efficiency.

While in the foregoing specification this invention has been described in relation to certain embodiments thereof and many details have been set forth for the purpose of illustration, it will be apparent to those skilled in the art that the invention is susceptible to additional embodiments and that certain of the details described herein can be varied considerably without departing from the basic principles of the invention.

What is claimed is:

1. A communication system, comprising:
a communication device for transmitting a first verbal communication in a first language;
a translation module for receiving the first verbal communication, the translation module possessing a capability of generating a second verbal communication in a second language;
an operator terminal for receiving the second verbal communication from the translation module; and
a communication link for transmitting a third verbal communication in the second language from the operator terminal to the translation module,
wherein the translation module additionally possesses a capability of generating and transmitting a fourth verbal communication in the first language to the communication device.

2. The communication system of claim 1, wherein the translation module comprises a transcription unit possessing a capability of generating a first transcript and a voice generation unit.

3. The communication system of claim 2, wherein the voice generation unit possesses a capability of translating the first verbal communication directly into the second verbal communication.

4. The communication system of claim 2, wherein the voice generation unit possesses a capability of receiving the first transcript from the transcription unit and generating the second verbal communication from the first transcript.

5. The communication system of claim 2, wherein the voice generation unit possesses a capability of directly translating the third verbal communication into the fourth verbal communication.

6. The communication system of claim 2, wherein the transcription unit possesses a capability of receiving a second transcript from the operator terminal and generating a third transcript in the first language.

7. The communication system of claim 6, wherein the voice generation unit possess a capability of receiving the third transcript from the transcription unit and generating the fourth verbal communication from the third transcript.

8. The communication system of claim 2, wherein the communication device comprises a text unit for sending, receiving or a combination thereof a text message in the first language.

9. The communication system of claim 8, wherein the transcription unit possesses a capability of translating a second transcript from the operator terminal into a text message in the first language and transmitting the text message to the text unit

10. A communication system comprising:
a communication device for transmitting a verbal communication in a first language;
a translation module for receiving and sending verbal communications, written communications or combinations thereof, the translation module including:
a voice generation unit possessing a capability of translating the first verbal communication into a second verbal communication in a second language, and
a transcription unit possessing a capability of transcribing the first verbal communication into a first transcript in the second language;
a first communication link for transmitting the second verbal communication and the first transcript;
an operator terminal for receiving the second verbal communication and the first transcript, the operator terminal including:
an audio device for inputting a third verbal communication in the second language, and
a text input device for generating a second transcript in the second language;
a second communication link for transmitting the third verbal communication to the voice generation unit, the voice generation module possessing a capability of generating a fourth verbal communication in the first language; and
a third communication link for transmitting the fourth verbal communication to the communication device.

11. The communication system of claim 10, wherein the communication device is operably connected to a wired, wireless, voice over internet protocol, shortwave or two-way communication network.

12. The communication system of claim 10, wherein the communication device comprises a text unit possessing a capability of receiving and displaying a text message in the first language.

13. The communication system of claim 12, wherein the transcription unit possesses a capability of generating the text message in the first language.

14. The communication system of claim 13, further comprising a text link for transmitting the text message from transcription unit to the text unit.

15. The communication system of claim 10, further comprising a remote terminal, the remote terminal possessing a capability of receiving a copy of a communication selected from the group consisting of the first, second or third verbal communication, the first or second transcripts, and combinations thereof.

16. A method for responding to an emergency communication, comprising:
accessing the communication system of claim 10;
transmitting the first verbal communication from the communication device to the translation module wherein the first verbal communication is translated into the second verbal communication and the first transcript;
transmitting the second verbal communication and tire first transcript via the first communication link to the operator terminal;
inputting the third verbal communication using the audio device;
transmitting the third verbal communication via the second communication link to the voice generation unit wherein the fourth verbal communication is generated; and
transmitting the fourth verbal communication to the communication device via the third communication link.

17. The method of claim 16, further comprising:
generating the second transcript using the text input device;
transmitting the second transcript to the transcription unit via a fourth communication link, wherein the transcription module generates a text message in the first language; and
transmitting the text message to a text unit included in the communication device via a text link.

18. A communication system, comprising:
a communication device for transmitting a first verbal communication in a first language;
an automated menu module for receiving the first verbal communication, the automated menu module possessing a capability of identifying the first language, transmitting queries in the first language to the communication device, and receiving commands in the first language in response to the queries;
a translation module for receiving the first verbal communication and a query/command string in the first language from the automated menu module, the translation module possessing a capability of translating the first verbal communication into a second verbal communication in a second language, and transcribing the first verbal communication and the query/command string into a first transcript in the second language; and
an operator terminal for receiving the second verbal communication and the first transcript, the operator terminal possessing a capability of generating and transmitting a third verbal communication in the second language to the translation module,
wherein the translation module further possess a capability of translating the third verbal communication into a fourth verbal communication in the first language and transmitting the fourth verbal communication to the communication device.

19. The communication system of claim 18, wherein the automated menu module possesses a capability of searching a language database to identify the first language, selecting a preprogrammed menu based upon the identified first language, and transmitting at least one query in the identified first language from the preprogrammed menu to the communication device.

20. The communication system of claim 18, wherein the automated menu module possesses the capability of transmitting the first verbal communication and the query/command string to the translation module in response to a command from a caller or response to a predetermined query/command string length.
